(19) United States
(12) Patent Application Publication
(10) Pub. No.: US 2021/0316941 A1
(43) Pub. Date: Oct. 14, 2021

(54) CONTAINER FOR THERMOSTABLE STORAGE AND/OR SHIPMENT OF PRODUCTS

(71) Applicant: EXAM PACKAGING, Ciney (BE)

(72) Inventors: Alexandre LE JEUNE D'ALLEGEERSHECQUE, Bruxelles (BE); Ingrid DE BOCK, Merchtem (BE); Céline PIRLOT, Ciney (BE)

(21) Appl. No.: 17/229,714

(22) Filed: Apr. 13, 2021

(30) Foreign Application Priority Data
Apr. 14, 2020 (BE) BE2020/5241

(51) Int. Cl. B65D 88/74; G01K 1/022

(52) U.S. Cl. CPC B65D 88/74; G01K 1/022

(57) ABSTRACT

The present invention relates to a container (1) for thermostable storage and/or shipment of products, the container (1) comprising panels (72a-e) of thermal conductivity less than 0.005 W m⁻¹ K⁻¹ assembled by a first material (71) so as to form a monobloc.

### TECHNICAL FIELD

The present invention relates to a container for thermostable storage and/or shipment of products.

### BACKGROUND

It is known to maintain the contents of a container at a stable temperature by active means, for example by a refrigerator.

It also exists containers that can maintain their contents at a constant temperature passively, i.e. without a compressor or electrical power.

For larger volumes, typically a volume transported by a pallet, the document WO2019/177682A1 describes a temperature controlled pallet shipping device.

Documents WO03/083386 A1, US2020/102134 A1, DE202014004515 U1, and US2011/147391 A1 disclose containers each comprising an assembly of panels.

Such assemblies typically leave some gap between the panels, which can create thermal bridges.

Document US2014/353317 A1 describes an assembly of panels with a shell formed from an expanded foam of expanded polystyrene or expanded polypropylene.

### SUMMARY OF THE INVENTION

It is an object of the present invention to provide a container that can passively maintain its contents within a certain temperature range for several days.

The invention relates to a container for thermostable storage and/or shipment of products, intended to contain an internal volume of at most 5000 litres, and comprising a module comprising:
a first wall,
a second wall opposite the first wall,
a third wall joining the first and second walls,
a fourth wall joining the first and second walls,
a fifth wall joining the first and second walls, and the third and fourth walls, and
an opening;
   the container further comprising a lid for closing the opening;

wherein:
the module comprises a first material and a plurality of panels comprising at least a first, a second, a third, a fourth, and a fifth panels;
the first, second, third, fourth, and fifth panels are at least partially covered with the first material;
the first wall comprises at least a part of the first panel, the second wall comprises at least a part of the second panel, the third wall comprises at least a part of the third panel, the fourth wall comprises at least a part of the fourth panel, and the fifth wall comprises at least a part of the fifth panel;
the first, second, third, fourth, and fifth panels are secured together by the first material so that the first material and the first, second, third, fourth, and fifth panels form part of a monobloc element; and
the first material is polyurethane and has a thermal conductivity of less than 0.05 W m⁻¹K⁻¹, and the first, second, third, fourth, and fifth panels have a thermal conductivity of less than 0.005 W m⁻¹ K⁻¹.

The module of the invention comprises at least two low thermal conductivity materials. The panels, due to their very low thermal conductivity, provide an excellent thermal blocking perpendicular to the walls. The panels and the first material together form a monobloc, allowing in particular to avoid the thermal bridges between the outside and the inside of the container.

As the five panels of the five walls of the module are of one piece with the first material, the whole forms a monobloc which does not induce thermal bridges, unlike assembled modules which naturally have thermal bridges. These advantages lead to an indirect economic gain, particularly in view of the reduction in temperature excursions.

The module is very easy to use because it does not need to be assembled, so the operators are trained very quickly in its use. In addition, the risk of making mistakes, especially in assembly, is low. In addition, only one person is needed to position shelves and temperature control elements.

It is interesting to note that document US2014/353317 A1 advises against the use of polyurethane. Despite such a prejudice, the inventors have chosen to use this material in particular because it has excellent anti-penetration properties, which prevents opening the container other than by opening the lid. Polyurethane also helps prevent impacts from piercing surfaces, resulting in thermal bridges.

The crush resistance of the module according to the invention makes it possible to stack several containers according to the invention on top of each other. This resistance, combined with the puncture resistance of the module, results in particularly high protection of the contents. For example, a prototype of the container according to the invention withstood a mass of several tonnes.

The characteristics of the container according to the invention contribute to the fact that it allows a large internal volume to be maintained at a particularly stable temperature for a particularly long period of time, of at least one week. Thus, the container according to the invention allows, for example, certain products to be transported by sea or by train instead of by air, which is an economic and ecological advantage. In addition, for the same means of transport, for example by road, greater distances can be covered.

The invention is particularly suitable for, but not limited to, maintaining a temperature lower than the outside temperature. It can also, for example, be used to maintain products at 5° C. with an outside temperature of 20° C. or −20° C.

The monobloc element comprising the five walls and the first material is a part of the module, or is the module itself. The first material is itself monobloc.

The internal volume of the container is the volume inside the space defined by the module and the lid, when the lid closes the opening. The container is preferably intended to have an internal volume between 1 and 5000 litres, more preferably between 200 and 2000 litres.

The walls are preferably planar. The second wall is preferably parallel to the first wall. The third, the fourth and the fifth walls are preferably perpendicular to the first and second walls. The third and the fourth walls are preferably parallel. The lid is preferably planar.

The first wall is preferably arranged to rest on a pallet. The first and the second walls are preferably horizontal. The third, the fourth and the fifth walls are preferably vertical. The lid is preferably vertical.

The panels have a first and a second planar surfaces separated by a thickness. Preferably, the first material completely covers the first and/or the second surface of each of the first, second, third, fourth, and fifth panels.

The first material and the panels are held together by chemical adhesion. The first material has a thermal conductivity preferably less than 0.03 W m⁻¹ K⁻¹, more preferably between 0.015 and 0.025 W m⁻¹ K⁻¹. The panels have a thermal conductivity preferably less than 0.005 W m⁻¹ K⁻¹, more preferably between 0.0010 and 0.0050 W m⁻¹ K⁻¹.

In an embodiment of the invention, the first wall is rectangular and has a width of at least 500 mm and a depth of at least 500 mm. As the first wall is preferably intended to rest on a pallet, it is of interest that it has a width and a depth of at least 500 mm. Any size of the first wall and of the pallet is possible within the scope of the invention.

The first wall preferably has a width greater than its depth. The second wall preferably has the same width and the same depth as the first wall. For example, the container may be 1200 mm wide, 1000 mm deep and 1500 mm high, or 1200 mm wide, 800 mm deep and 1200 mm high.

In an embodiment of the invention, the first material has a density between 30 and 100 kg/m³. Preferably, the first material has a density between 35 and 60 kg/m³.

In an optional embodiment of the invention, the first, second, third, fourth, and fifth panels are planar. These may be rectangular parallelepipeds, for example rectangular parallelepipeds having planar or cut at an angled edges, with a “L” shape or a “U” shape.

In an embodiment of the invention, each of the first to fourth panels has a first end and a second end, each of the first ends being in contact with the second end of another of the first to fourth panels such that an overlap exists between the first end of each of the first to fourth panels and the second end of another of the first to fourth panels. This overlap prevents the thermal bridges. For example, the first wall comprises a first end of the third panel, the fourth wall comprises a first end of the first panel, the second wall comprises a first end of the fourth panel, and the third wall comprises a first end of the second panel. Thus, on the circumference of the module formed by the first to fourth walls, the end of one panel forms the corner with the adjacent wall. This avoids the thermal bridges in the corners of the module.

In an embodiment of the invention, the first, second, third, fourth and fifth walls, and preferably the lid, have an inner surface covered, at least partially and preferably completely, by a second material, preferably hydrophobic.

In an embodiment of the invention, the first, second, third, fourth and fifth walls, and preferably the lid, have an outer surface covered, at least partially and preferably completely, by a third material, preferably hydrophobic. In particular, the third material improves the penetration resistance of the container, and its robustness during a fall.

In an embodiment of the invention, the first, second, third, fourth and fifth walls, and preferably the lid, have an outer and/or inner surface protected at least partially and preferably completely by a reinforcement made of a fourth material, preferably hydrophobic.

In particular, the covering and/or the inner and/or outer reinforcement prevents damage to the first material and/or the panels. A hydrophobic material is particularly convenient if the container needs to be cleaned between uses.

In an embodiment of the invention, the container is reusable.

In an embodiment of the invention, the container is particularly resistant to localised or non-localised impacts. This allows for the safe transport of hazardous materials.

In an embodiment of the invention, the container comprises a fifth material, at least as compressible, preferably more compressible, than the material forming the inner surface of the lid, at the interface between the module and the lid. For example, the fifth material is at least as compressible, preferably more compressible, than the second and/or the fourth material. The fifth material is located on the parts of the module in contact with the lid and/or on the parts of the lid in contact with the module. Its compressibility allows it to prevent clearances from being created between the module and the cover, thus avoiding the thermal bridges.

The invention further provides a temperature maintenance system comprising a container according to any embodiment of the invention and temperature control elements comprising one or more phase change materials. The phase change material may be selected so that its phase change temperature is within the temperature range desired to be maintained in the container, or so that its phase change temperature is lower than the temperature range desired to be maintained inside the container. For example, the phase change temperature may be between 2° C. and 8° C.

The phase change material may be any phase change material, comprising any water-based or organic phase change material. For example, if the phase change material is water-based, the phase change material may be water, a mixture of water and a thickener (e.g. a polysaccharide thickener) to produce a gelled water mixture, or a water/salt solution with an optional thickener. If the phase change material is an organic phase change material, the phase change material may be a gelled organic phase change material, as described in the documents U.S. Pat. No. 9,598,622 B2 and US 2018/0093816 A1. More specifically, a suitable gelled organic phase change material may comprise one or more n-alkanes, such as the n-tetradecane (C14), the n-pentadecane (C15), the n-hexadecane (C16), the n-heptadecane (C17), the n-octadecane (C18), or theirs combinations, together with, for example, a gelling agent in the form of a styrene-ethylene-butylene-styrene triblock copolymer and/or a styrene-ethylene-propylene-styrene triblock copolymer. For the maintenance in a temperature range between 2° C. and 8° C., the gelled phase change material may for example comprise a mixture of n-tetradecane (C14) and KRATON™ G1654 styrene-ethylene-butylene-styrene triblock copolymer (SEBS).

In an embodiment of the invention, the storage system comprises shelves provided to receive the temperature control elements. Preferably, the shelves are arranged so that the temperature control elements are aligned in a row or stacked one above the other. If the temperature control elements have a rectangular parallelepiped shape with two first surfaces larger than the other four surfaces, the shelves are preferably arranged so that the first surfaces of the temperature control elements are aligned. The shelves are made of a material to limit thermal shock.

In an embodiment of the invention, the storage system comprises boxes in which the temperature control elements are aligned or stacked. If the storage system comprises shelves, these are preferably provided to receive the boxes. The storage system can be arranged in many ways within the scope of the invention.

Preferably, the boxes each receive one or more lines of temperature control elements. The boxes are preferably made of a material that limits thermal shock.

The shelves preferably comprise locations such that the boxes are held in place.

In an embodiment of the invention, between one and six shelves are preferably located perpendicular to the inner surfaces of the first, second, third, and/or fourth walls and, at least partially, along the inner surfaces of the first, second, third, and/or fourth walls. They preferably have an access leading to the opening of the module.

This allows the temperature control elements to be easily placed in the container once it is opened. Only one person is required to place the temperature control elements.

Preferably, the shelves are arranged so that the first surfaces of a cooling element are parallel to the wall along which this cooling element is placed.

The invention also relates to an arrangement comprising a container according to the invention, and/or a temperature maintenance system according to the invention. The arrangement also comprises a thermometer located in the container and a memory provided for storing data from temperature measurements made by the thermometer. The memory may be, for example, in the container, attached to the outside of the container and/or in an electronic device external to the container. The thermometer is preferably within the internal volume of the container.

The invention also relates to the manufacture and the use of a container according to the invention and/or a cold maintenance system according to the invention.

### BRIEF DESCRIPTION OF FIGURES

Other characteristics and advantages of the invention will become apparent from the following detailed description, for the understanding of which reference is made to the appended figures, among which:

FIG. 1a is a front view of a module in an embodiment of the invention,

FIG. 1b is a side view of a module in an embodiment of the invention,

FIG. 2 is a front view of a lid in an embodiment of the invention,

FIG. 3 is a horizontal sectional view of a container in an embodiment of the invention,

FIG. 4a is a front view of a panel arrangement in an embodiment of the invention,

FIG. 4b is a top view of a panel arrangement in the same embodiment of the invention as FIG. 4a,

FIG. 5a illustrates a possible arrangement of two parts of the same panel,

FIG. 5b illustrates a possible arrangement of two panels,

FIG. 5c illustrates another possible arrangement of two panels,

FIG. 5d illustrates a possible arrangement of the first to fourth panels,

FIG. 6a is a horizontal sectional view corresponding to a vertical edge of a module according to a first embodiment of the invention,

FIG. 6b is a horizontal sectional view corresponding to a vertical edge of a module according to a second embodiment of the invention,

FIG. 6c is a horizontal sectional view corresponding to a vertical edge of a module according to a third embodiment of the invention,

FIG. 7 is a front view of a cold maintenance system in an embodiment of the invention, in which some filled shelves are shown,

FIG. 8 is a cross-sectional view of a box in an embodiment of the invention,

FIG. 9 is a block view of an arrangement in an embodiment of the invention, and

FIG. 10 is an experimental graph illustrating results of measurements made with a container according to an embodiment of the invention compared to a container without the characteristics of the invention.

### EMBODIMENTS OF THE INVENTION

The present invention is described with particular embodiments and references to figures, but the invention is not limited thereby. The drawings or figures described are schematic only and are not limiting.

In the context of this document, the terms “first” and “second” are used only to differentiate between the various elements and do not imply any order between these elements. Furthermore, it is possible for the container according to the invention to comprise, for example, an element in a “third” material without comprising an element in a “second” material.

In the figures, the same or similar elements may have the same references.

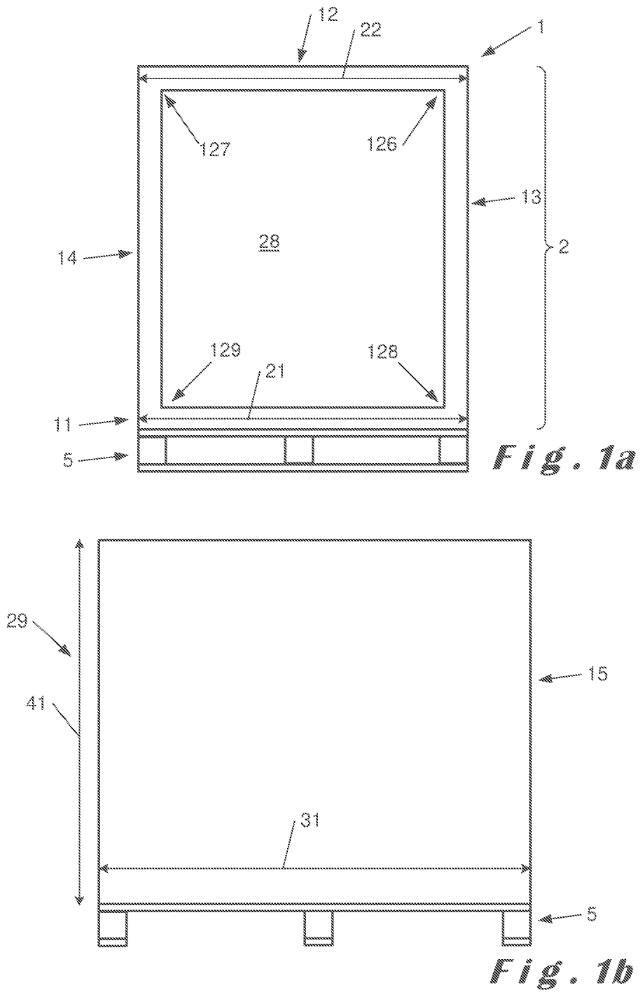

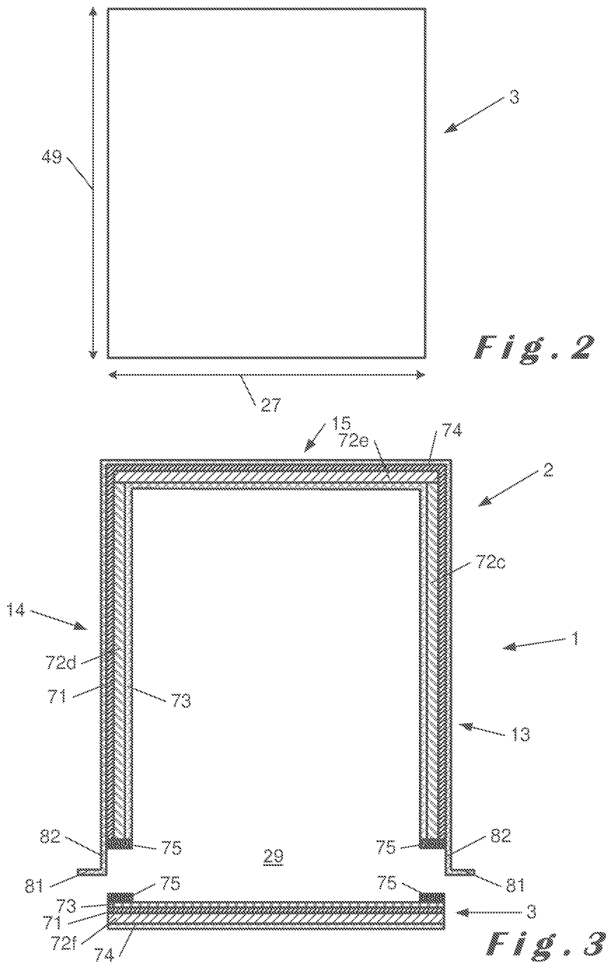

The present invention relates in particular to a container 1 for thermostable storage and/or shipment of products. The container 1 comprises a module 2 and a lid 3. The module 2 is illustrated in FIGS. 1a and 1b. It comprises five walls: a first 11, a second 12, a third 13, a fourth 14, and a fifth wall 15; and an opening 29. The walls 11-15 are preferably rectangular and arranged so that the module 2 is shaped like a rectangular parallelepiped, with the opening 29 forming one side. The lid 3 is illustrated in FIGS. 2 and 3.

The container 1 can enclose an internal volume 28 of up to 5000 litres.

The first wall 11 is intended to be arranged on a pallet 5. The first 11 and the second 12 walls preferably have a width 21 and 22 of at least 500 mm and a depth 31 of at least 500 mm. The third 13 and fourth 14 walls preferably have a depth 31 of at least 500 mm and a height 41 of at least 400 mm. The fifth wall 15 preferably has a width 21 of at least 500 mm and a height 41 of at least 400 mm.

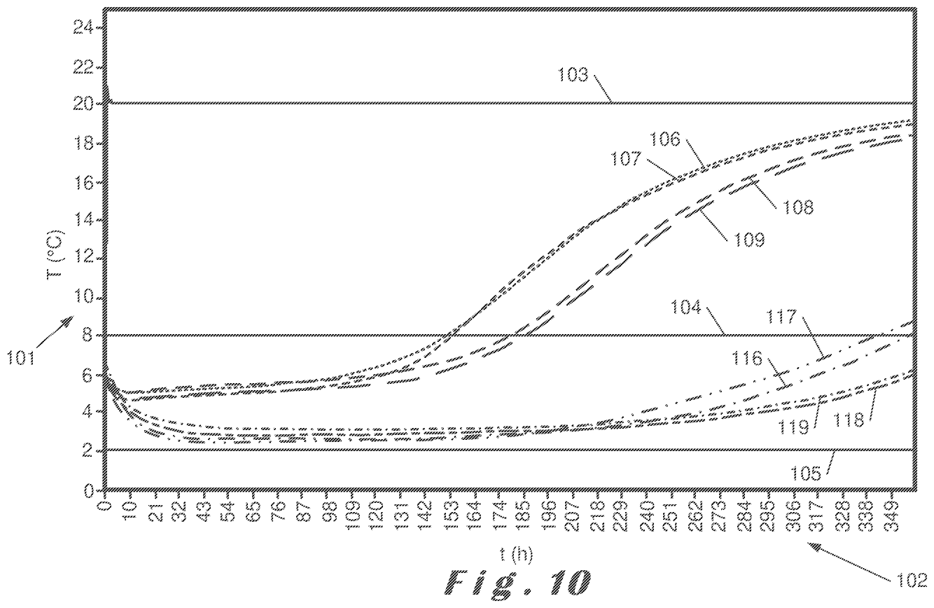

The references 126, 127, 128 and 129 will be used with reference to FIG. 10.

The lid 3 (shown in FIG. 2) preferably has a width 27 of at least 500 mm and a height 49 of at least 400 mm.

FIG. 3 is a horizontal cross-sectional view of a container 1 according to an embodiment of the invention, showing the lid 3 separate from the module 2. The module 2 comprises a first material 71, which is monobloc, and at least five panels: a first 72a, a second 72b, a third 72c, a fourth 72d, and a fifth 72e panels. The panels 72a-e are preferably planar. They potentially comprise cut-outs on their end sides. The panels 72a-e are at least partially covered with the first material 71. Each of the five walls 11-15 comprises, at least partially, one of the panels 72a-e. The five panels 72a-e are held in a fixed position relative to each other by the first material 71. Preferably, the lid 3 comprises a sixth panel 72f at least partially covered by the first material 71.

In an embodiment of the invention, the container 1 comprises a second material 73 covering, at least partially and preferably completely, its inner surface when the lid 3 closes the opening 29. The second material 73 covers the inner surface of the first 11, second 12, third 13, fourth 14 and fifth 15 walls, and preferably at least partially the inner surface of the lid 3.

In an embodiment of the invention, the container 1 comprises a third material 74 covering, at least partially and preferably completely, its outer surface when the lid 3 closes the opening 29. The third material 74 covers the outer surface of the first 11, second 12, third 13, fourth 14 and fifth 15 walls, and preferably at least partially the outer surface of the lid 3.

In an embodiment of the invention, the third material 74 protrudes from the first 11, second 12, third 13, and fourth 14 walls, in an extension 82 that allows the lid 3 to be received against the module 2. Preferably, the third material 74 forms flaps 81 which allow the lid 3 to be locked against the module 2 when folded over the outer surface of the lid 3. The flaps 81 may, for example, be held closed by a fastener such as a strap or a Velcro.

In an embodiment of the invention, the container 1 comprises a fifth material 75 disposed at the contact areas between the module 2 and the lid 3, i.e. at the interface between the module 2 and the lid 3. For example, the module 2 may comprise an element having the shape of a perimeter edge of a rectangle around the opening 29 (as illustrated in FIG. 7). The fifth material 75 has a higher compressibility than the first material 71.

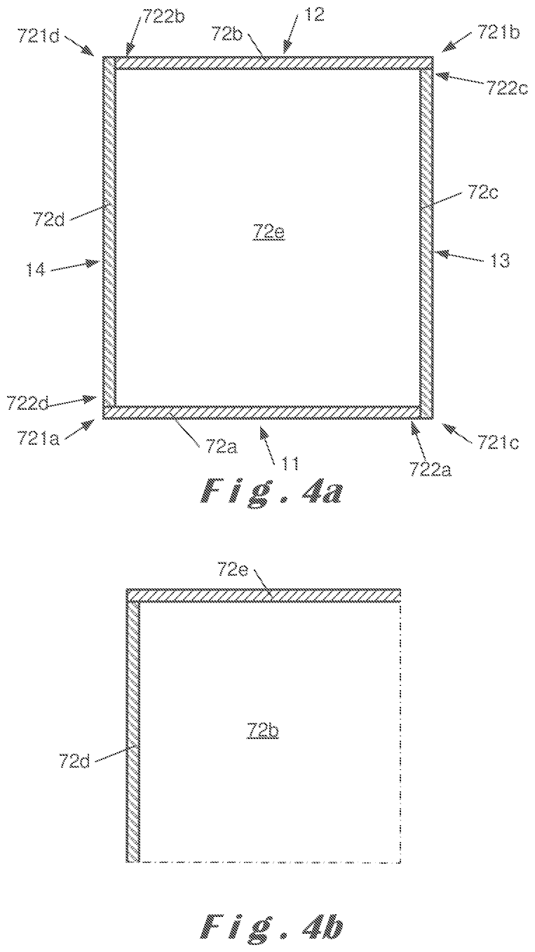

FIG. 4a illustrates a possible arrangement of the first, second, third, and fourth panels 72a-d. The first to fourth panels 72a-d, which are optionally rectangular parallelepipeds, are arranged so that their edges form a rectangle where one of the two smaller sides of one panel meets one of the larger sides of the preceding panel, the two panels being perpendicular. In other words, the first wall 11 comprises a first end 721c of the third panel 72c, the fourth wall 14 comprises a first end 721a of the first panel 72a, the second wall 12 comprises a first end 721d of the fourth panel 72d, and the third wall 13 comprises a first end 721b of the second panel 72b.

Each panel 72a-72d comprises a second end 722a-d opposite the first end 721a-d (by end, of course, is meant end side). In general, the invention provides embodiments where:
the first end 721a of the first panel 72a is in contact with the second end 722d of the fourth panel 72d so that an overlap exists;
the first end 721d of the fourth panel 72d is in contact with the second end 722b of the second panel 72b so that an overlap exists;
the first end 721b of the second panel 72b is in contact with the second end 722c of the third panel 72c so that an overlap exists; and
the first end 721c of the third panel 72c is in contact with the second end 722a of the first panel 72a so that an overlap exists.

The fifth panel 72e closes one side of the module 2 by being arranged to overlap the edges of the first to fourth panels 72a-d as illustrated in FIG. 4b. To this end, the fifth panel 72e may have a width equal to the sum of the width of the second panel 72b and the thickness of the fourth panel 72d.

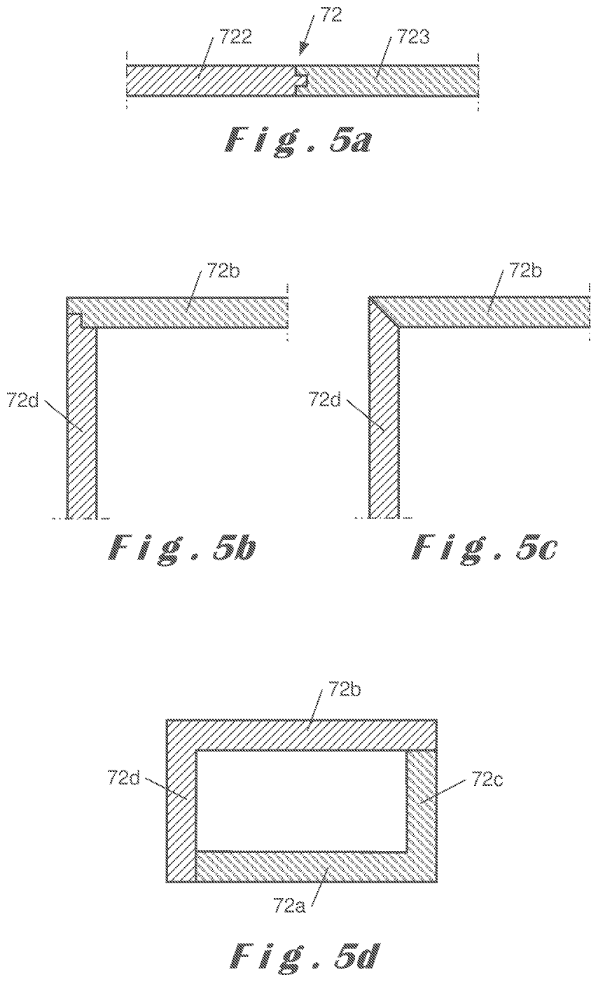

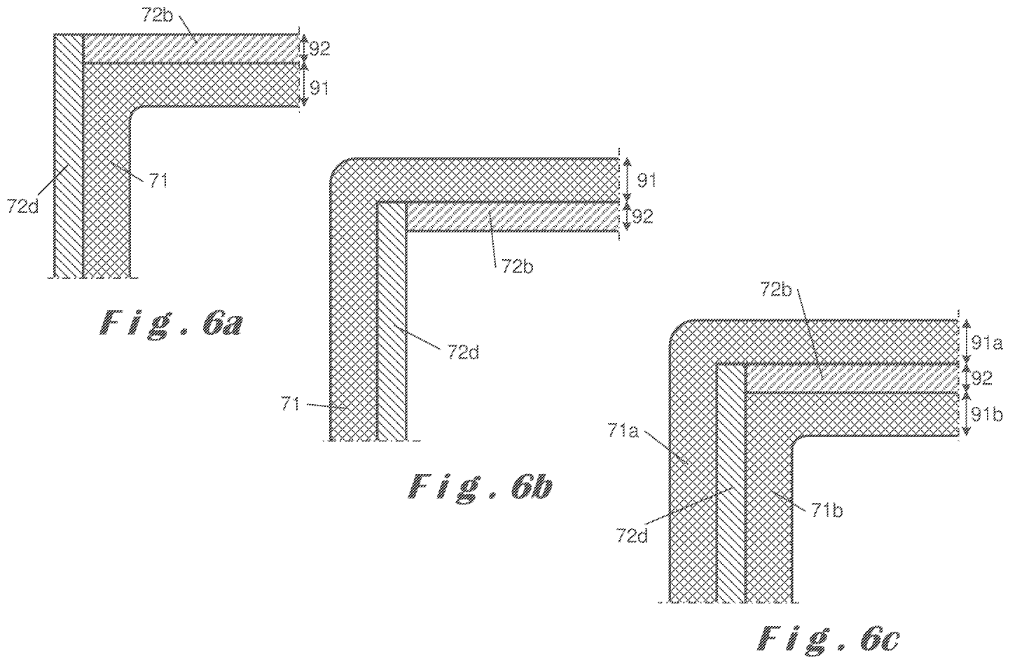

FIG. 5a illustrates a possible arrangement of two parts 722, 723 of a panel which may be any of the first 72a to sixth 72f panels. The first part 722 of the panel 72 comprises a tenon and the second part 723 comprises a mortise.

FIG. 5b illustrates a possible arrangement of two panels, for example the second 72b and fourth 72d panels. The thickness of each of the panels comprises a cut-out to allow an interlocking.

FIG. 5c illustrates a possible arrangement of two panels, for example the second 72b and fourth 72d panels. The thickness of each of the panels is cut at an angle to allow an interlocking.

FIG. 5d illustrates a possible arrangement of the first 72a to fourth 72d panels. In this embodiment, the panels are secured in pairs, or are made of one piece, prior to the assembly by the first material 71.

FIGS. 5b, 5c, 5d illustrate embodiments in which each of the first ends 721a-d of the first to fourth panels 72a-d is in contact with the second end 722a-d of an adjacent panel such that an overlap exists between the first end 721a-d of each of the first to fourth panels 72a-d and the second end 722a-d of an adjacent panel.

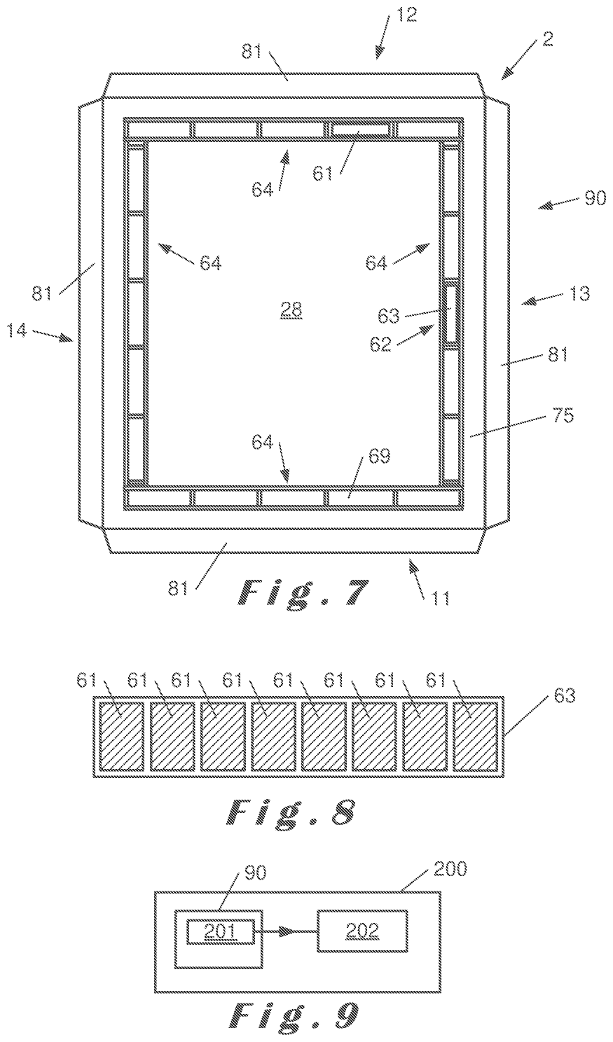

FIG. 6a illustrates a first possible arrangement of the first, second, third, fourth, and fifth panels 72a-e with respect to the first material 71, wherein the first material 71 covers the inner surfaces of the five panels 72a-e.

FIG. 6b illustrates a second possible arrangement of the first, second, third, fourth, and fifth panels 72a-e with respect to the first material 71, wherein the first material 71 covers the outer surfaces of the five panels 72a-e.

FIG. 6c illustrates a third possible arrangement of the first, second, third, fourth, and fifth panels 72a-e with respect to the first material 71, wherein the first material 71 covers the inner surfaces and the outer surfaces of the five panels 72a-e, so as to provide an outer layer 71a and an inner layer 71b. The outer layer 71a is preferably, but not necessarily, monobloc with the inner layer 71b.

The first material 71 preferably has a thickness 91 between 10 and 80 mm, more preferably between 30 and 60 mm, for example 40 mm. In the third arrangement, the thickness 91a or 91b of each of the layers, or the sum 91a+91b of the thicknesses of each of the layers, may be between 10 and 80 mm, more preferably between 30 and 60 mm, for example 40 mm.

The panels 72a-e preferably have a thickness 92 between 5 and 50 mm, more preferably between 15 and 25 mm, for example 20 mm.

FIG. 7 illustrates a temperature maintenance system 90, the purpose of which is to keep the contents of the container within a temperature range within a determined time period, and comprising a container 1 according to any embodiment of the invention, and temperature control elements 61 comprising a phase change material.

FIG. 7 also illustrates a storage system 62 for holding the temperature control elements 61 in place. The storage system 62 may hold in place the temperature control elements 61 themselves and/or boxes 63 containing the temperature control elements 61. For example, the storage system 62 may comprise between one and six shelves 64 for receiving and locking the temperature control elements 61 themselves and/or the boxes 63. The position of the shelves 64 is preferably flexible.

In an embodiment of the invention, the shelves 64 are located, at least partially, along the inner surfaces of the first 11, second 12, third 13, and/or fourth 14 walls, and have an access 69 leading to the opening 29 of the module 2. Such shelves 64 preferably extend over the entire depth of the first 11, second 12, third 13, and fourth 14 walls.

For example, it is possible to place a plurality of temperature control elements 61 in boxes 63 (as illustrated by the example in FIG. 8), and then slide the boxes 63 into the shelves 64, as shown on the right of FIG. 7. A box 63 may, for example, comprise temperature control elements 61 aligned in a single row or distributed in two or more rows. A box 63 may comprise overlapping rows of temperature control elements 61. Alternatively, the temperature control elements 61 may be placed in the shelves 64 as shown at the top of FIG. 7.

FIG. 9 illustrates an embodiment of the invention which relates to an arrangement 200 comprising a temperature maintenance system 90 according to the invention, a thermometer 201 located in the container 1 of the temperature maintenance system 90, and a memory 202 storing data from temperature measurements made by the thermometer 201. The memory 202 may be for example in an electronic device external to the container 1 and receiving information from the thermometer 201. This allows a real time monitoring of the temperature. The memory 202 may be in the container 1 and collect data from temperature measurements made by the thermometer 201, in order to check, after opening the container 1, whether the internal temperature has remained within the desired range.

FIG. 10 shows experimental results of temperature 101 versus time 102 expressed in hours. The curve 103 is the temperature of the room in which the experiment takes place. The line 104 is at 8° C., which is a usual threshold in the field, and the line 105 is at 2° C.

The curves 106, 107, 108, 109 correspond respectively to two upper corners, back 126 and front 127, and two lower corners, back 128 and front 129 (FIG. 1a), of a container which does not comprise panels (called container A). The curves 116, 117, 118, 119 correspond respectively to two upper corners, back 126 and front 127, and two lower corners, back 128 and front 129 (FIG. 1a), of a container according to the invention (called container B).

These experimental data show the effect of the container 1 according to the invention: with such a container, it is possible to maintain a temperature below 8° C. for 2 weeks (=336 hours).

The dimensions of the containers used for these measurements are given in the table below. The first material 71 is polyurethane. The panels 72a-f of the container B are vacuum insulation panels.

| | Container A | Container B |
|---|---|---|
| | (reference) | (invention) |
| External dimensions: width 21 × | 1.190 × 985 × | 1.190 × 985 × |
| depth 31 × height 41 (mm) | 1.415 | 1.415 |
| Internal dimensions: width × | 1.065 × 860 × | 1.065 × 860 × |
| depth × height (mm) | 1.297 | 1.297 |
| Thickness 91 of the first material | 57 | 37 |
| 71 (mm) | | |
| Thickness 92 of the panels 72a-f (mm) | / | 20 |
| Thickness of second material 73 (mm) | 1 | 1 |
| Thickness of the third material 74 (mm) | 3 | 3 |

In general, the outer surface of the container 1 may be modified to comprise handling means. Examples of such handling means comprise, but are not limited to, straps, and handles.

In general, the container 1 may comprise bubble wrap in one or more locations, for example, to reduce thermal shock or to provide better thermal insulation of the container. Bubble wrap may surround the product, surround the shelves, surround the container, . . . .

In other words, the invention relates to a container 1 for thermostable storage and/or shipment of products comprising panels 72a-e with a thermal conductivity of less than 0.005 W m⁻¹ K⁻¹ assembled by a first material 71 so as to form a monobloc.

The present invention has been described in relation to specific embodiments, which are purely illustrative and should not be considered as limiting. In general, the present invention is not limited to the examples illustrated and/or described above. The use of the verb “comprise”, or any other variant, as well as its conjugations, can in no way exclude the presence of elements other than those mentioned. The use of the indefinite article “a”, “an”, or the definite article “the”, to introduce an element does not exclude the presence of a plurality of such elements. The reference numbers in the claims do not limit their scope.

1. A container for thermostable storage and/or shipment of products, intended to contain an internal volume of at most 5000 litres, and comprising a module comprising:
a first wall,
a second wall opposite the first wall,
a third wall joining the first and second walls,
a fourth wall joining the first and second walls,
a fifth wall joining the first and second walls, and the third and fourth walls, and
an opening;
the container further comprising a lid for closing the opening;
wherein:
the module comprises a first material and a plurality of panels comprising at least a first, a second, a third, a fourth, and a fifth panels;
the first, second, third, fourth, and fifth panels are at least partially covered with the first material;
the first wall comprises at least a part of the first panel, the second wall comprises at least a part of the second panel, the third wall comprises at least a part of the third panel, the fourth wall comprises at least a part of the fourth panel, and the fifth wall comprises at least a part of the fifth panel;
the first, second, third, fourth, and fifth panels are secured together by the first material such that the first material and the first, second, third, fourth, and fifth panels form part of a monobloc element; and
the first material is polyurethane and has a thermal conductivity of less than 0.05 W m⁻¹ K⁻¹, the first, second, third, fourth, and fifth panels have a thermal conductivity of less than 0.005 W m⁻¹ K⁻¹.

2. The container according to claim 1, wherein the first wall is rectangular and has a width of at least 500 mm and a depth of at least 500 mm.

3. The container according to claim 1, wherein the first material has a density between 30 and 100 kg/m³.

4. The container according claim 1, wherein the first, second, third, fourth, and fifth panels are planar.

5. The container according to claim 1, wherein each of the first to fourth panels has a first end and a second end, each of the first ends being in contact with the second end of another of the first to fourth panels such that an overlap exists between the first end of each of the first to fourth panels and the second end of another of the first to fourth panels.

6. The container according to claim 1, wherein the first, second, third, fourth and fifth walls, and preferably the lid, have an inner surface covered, at least partially, by a second material.

7. The container according to claim 1, wherein the first, second, third, fourth and fifth walls, and preferably the lid, have an outer surface covered, at least partially, with a third material.

8. The container according to claim 1, wherein the first, second, third, fourth and fifth walls, and preferably the lid, have an outer and/or inner surface protected at least partially and preferably completely by a reinforcement made of a fourth material.

9. The container according to claim 1, comprising a fifth material, at least as compressible as the material forming the inner surface of the lid, at the interface between the module and the lid.

10. A temperature maintenance system comprising a container according to claim 1, and temperature control elements comprising a phase change material.

11. The system according to claim 10 comprising a storage system for holding the temperature control elements in place.

12. The system according to claim 11, wherein the storage system comprises between one and six shelves provided to receive the temperature control elements.

13. The system according to claim 11, wherein the storage system comprises boxes in which the temperature control elements are aligned or stacked.

14. The system according to claim 12, wherein the storage system comprises boxes in which the temperature control elements are aligned or stacked, the shelves being provided to receive the boxes.

15. The system according to claim 12, wherein the shelves are located, at least partially, along the inner surfaces of the first, second, third, and/or fourth walls, and have an access leading to the opening of the module.

16. The system according to claim 14, wherein the shelves are located, at least partially, along the inner surfaces of the first, second, third, and/or fourth walls, and have an access leading to the opening of the module.

17. An arrangement comprising a container according claim 1, a thermometer located in the container and a memory provided for storing data from temperature measurements made by the thermometer.

18. An arrangement comprising a temperature maintenance system according to claim 10, a thermometer located in the container and a memory provided for storing data from temperature measurements made by the thermometer.
